(19) United States
(12) Patent Application Publication
(10) Pub. No.: US 2009/0108592 A1
(43) Pub. Date: Apr. 30, 2009

(54) Storage Containers and Latch Systems for Storage Containers

(75) Inventor: Kevin De Vries, Monroe, IA (US)

Correspondence Address: DINSMORE & SHOHL, LLP, 1900 CHEMED CENTER, 255 EAST FIFTH STREET, CINCINNATI, OH, 45202, US

(73) Assignee: DEE ZEE, INC., Des Moines, IA (US)

(21) Appl. No.: 11/928,639

(22) Filed: Oct. 30, 2007

(51) Int. Cl. E05C 1/12; E05C 1/08

(52) U.S. Cl. 292/164; 292/138

(57) ABSTRACT

The present invention is directed to a latch assembly for releasably latching two components, including at least two of a latch base, a dowel, and a latch pin, wherein the latch pin is moveable with respect to the latch base. The latch assembly may be part of a latch system which includes the latch assembly and a receiving assembly and which can be used in storage containers, such as, a vehicle storage container.

### FIELD

The present invention is directed to latches which can be used as closures for various items, including, for example, vehicle storage containers.

### BACKGROUND

While there are currently many different types of latches on the market, they all generally suffer from the same Achilles' heel, rigidity. If the shape of the structure to which the latch is attached changes with age, damage, etc., or manufacturing tolerances are off, the rigid latch is unable to compensate for these changes or miscues and will no longer fit into its receiving assembly. Once this happens, the structure will no longer be able to be latched shut. As such, a need exists for a latch which has the ability to compensate for such changes or inaccuracies in the shape of a container.

### SUMMARY

One embodiment of the present invention is directed to a latch assembly for releasably latching two components. The latch assembly includes a latch base and a latch pin, wherein the latch pin is laterally moveable with respect to the latch base.

Another embodiment of the invention is directed to a latch system for a vehicle storage container, where the storage container has an open and closed position and can be moved between those positions. The latch system includes a latch assembly secured to a first portion of the storage container and a receiving assembly secured to a second portion of the storage container. The latch assembly is laterally moveable with respect to the receiving assembly.

In another embodiment, the invention is directed to a vehicle storage container. The vehicle storage container includes a container base, a container lid, and a latch system. The latch system includes a latch assembly secured to the container lid and a receiving assembly secured to the container base. The latch assembly comprises a latch base, and a latch pin, wherein at least a portion of the latch assembly is moveable with respect to the receiving assembly.

Additional embodiments, objects and advantages of the invention will become more fully apparent in the detailed description below.

### BRIEF DESCRIPTION OF THE DRAWINGS

The following detailed description will be more fully understood in view of the drawings in which:

FIG. 1 is an exploded view of a latch assembly according to one embodiment;

FIG. 2 is a perspective view of a latch assembly according to one embodiment;

FIG. 3 is a perspective view of a latch system, including a latch assembly and a receiving assembly attached to a storage container according to one embodiment;

FIG. 4 is a perspective view of a latch assembly on a container lid of a vehicle storage container according to one embodiment;

FIG. 5 is a perspective view of a latch assembly according to one embodiment; and

FIG. 6 is a perspective view of a vehicle storage container according to one embodiment.

The embodiments set forth in the drawings are illustrative in nature and are not intended to be limiting of the invention defined by the claims. Moreover, individual features of the drawings and the invention will be more fully apparent and understood in view of the detailed description.

### DETAILED DESCRIPTION

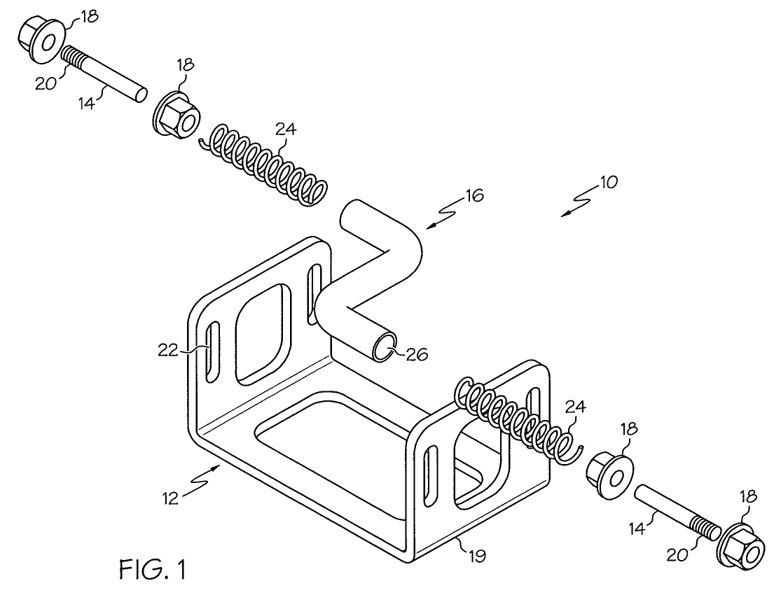

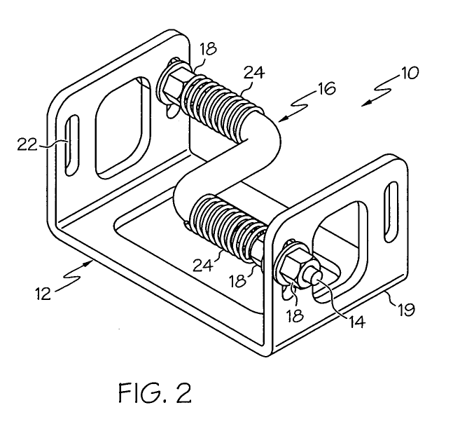

Referring to the drawings in detail, wherein like numerals indicate the same elements throughout the drawings, FIGS. 1-6 illustrate various embodiments of a latch system including a latch assembly and a receiving assembly for use with a vehicle storage container. Latches are generally used to hold two components together. They can be used, for example, in all sorts of doors, windows, containers, etc. The invention will be described in the context of its various configurations, however it should be appreciated that alternative arrangements of the invention can comprise any combination of such configurations. For example, features illustrated or described as part of one embodiment, can be used on another embodiment to make a further embodiment.

According to one embodiment of the present invention, a latch assembly 10 is provided which includes a latch base 12 and a latch pin 16. In a further embodiment, the latch assembly further comprises a dowel 14, (each of the base, pin and dowel are described with respect to components and operation more fully below). The latch base 12, dowel 14, and latch pin 16 can be made of any suitable material, for example, metal, aluminum, stainless steel, plastic, etc. In addition, these components can be any suitable shape, for example, square, rectangle, triangle, circular, oval, elliptical, polygonal, etc. and combinations thereof. Other features can be added to the overall shape of the latch base 12, dowel 14, and latch pin 16, in order to, for example, accommodate means of attachment or functionality. For example, the latch base 12 can have a channel 22 and the channel 22 can facilitate movement of the dowel 14 and latch pin 16 from an up position to a down position and vice versa. Additionally, the ends 26 of the latch pin 16 may be hollow so that they, will fit over the dowels 14 and will allow for the lateral movement of the latch pin 16 with respect to the latch base 12.

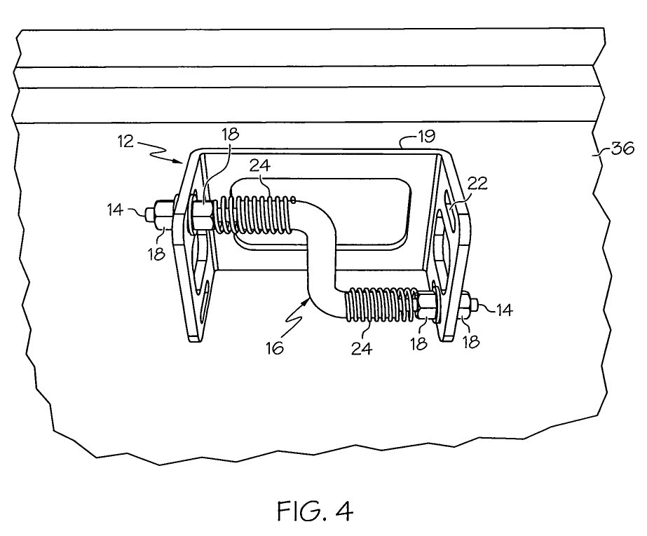

The latch base 12 will generally be mounted to one side of a closure, for example, a lid, and can be either fixed or moveable (e.g. FIG. 4). The latch base 12 may also comprise a mounting surface 19. The dowel 14 is generally attached to the latch base 12 and can be either fixed or moveable. When moveable, the dowel 14, for example, is moveable with respect to the latch base 12. Similarly, the latch pin 16 is generally attached to the dowel 14 and can be either fixed or moveable. When moveable, the latch pin 16, for example, is moveable with respect to either the latch base 12 or the dowel 14. Further, the components may be arranged in many combinations where, for example, some are moveable while others are fixed, all are moveable, all are fixed, or any combination of such, as described below.

The latch base 12, dowel 14, and latch pin 16 can be moveable in many directions. For example, in one embodiment, the latch pin 16 is moveable with respect to the latch base 12 laterally, vertically, or a combination thereof. The movement in these directions can occur in a straight line or in an angled variation, for instance, the movement could be a combination of horizontal and vertical movement because it is moving diagonally upward or downward. In one embodiment, the latch pin moves laterally in a linear path.

The latch base 12, dowel 14, and latch pin 16 may be attached to their respective components by any suitable means. For example, they may be attached via welds, adhesives, screws, nails, nuts and bolts, clamps, rivets, etc. They may also be attached by the fact that one piece rests over another piece. For example, the ends 26 of the latch pin 16, in one embodiment, are hollow and are slidably attached to the dowels 14 where the hollow ends 26 rest over at least a portion of the dowels 14. As will be understood by those skilled in the art, some of these attachment types will be more suited for fixed attachment (for example, welding) while others will be more suited for moveable attachment (for example, nuts and bolts). It should be noted, however, that many of the attachment types listed above can be used for both moveable and fixed attachment, for example, nuts and bolts.

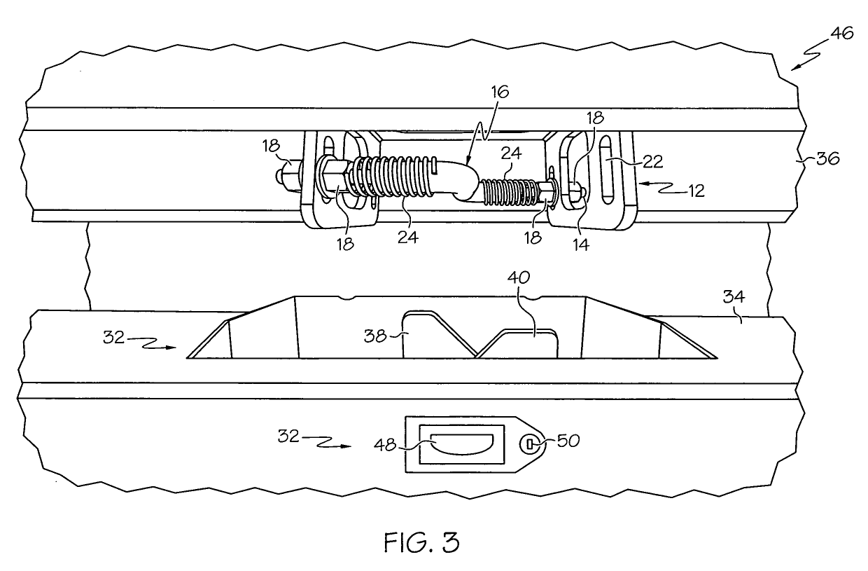

As seen in FIG. 3, the latch assembly 10 may also incorporate a receiving assembly 32. The receiving assembly 32 is configured to releasably retain the latch pin 16. Thus, the receiving assembly 32 will generally be located on a portion of an item opposite to the latch assembly 10 as these two pieces work in harmony to close an item. For example, looking to FIG. 3, in a vehicle storage container, the receiving assembly 32 would be located on the container base 34, while the latch assembly 10 would be located on the container lid 36. These opposing locations allow for the latch pin 16 to be releasably engaged by the receiving assembly 32 and thus close the box. The receiving assembly 32 can be of any appropriate size, shape, and material as long as it will releasably engage the latch pin 16. For example, as seen in FIG. 3, the receiving assembly 32 can include two opposable sides 38, 40, wherein the sides 38, 40 are configured to move away from one another upon receiving the latch pin 16 and further configured to move back toward each other and releasably engage the pin 16 upon completion of receipt. The receiving assembly may further include a release plate 48, which allows for the receiving assembly 32 to disengage the latch pin, and a lock 50. In another embodiment, the receiving assembly 32 further includes a guide plate (not pictures). In an additional embodiment, the receiving assembly 32 can be a rotary latch (not pictured) with either a single or dual rotor.

As can be seen from the above, the latch assembly 10 can involve many different variations of the latch base 12, dowel 14, latch pin 16, and receiving assembly 32, including, varying materials, shapes, and connections, and still fall within the scope of this application. To simplify the rest of the discussion, the detailed mechanics of the latch assembly 10 (without the receiving assembly) will be described with reference to one particular embodiment. However, it will be appreciated that the invention encompasses other embodiments and other uses in light of the disclosure above and that generally known in the art.

According to one particular embodiment, the latch assembly 10 includes a latch base 12. The latch base 12 is made of aluminum and has a U-shape as can be seen in FIG. 1. The dowel 14 has a uniform shape, like a rod, which can also be seen in FIG. 1. The dowel 14 is generally made of aluminum and comprises at least one engageable surface 20. A nut and bolt type mechanism is used to connect the dowel 14 to the latch base 12 through the channel 22. The engageable surface 20 of the dowel 14 fits into the channel 22 on the latch base 12 and is secured by at least one nut 18. The channel 22 allows for manual adjustment of the location of the dowel 14 along the latch base 12. Thus, if manufacturing tolerances make the location of the dowel 14 slightly off from where it needs to be, the user can loosen the nut and slide the dowel 14 along the channel 22 of the latch base 12 to the appropriate position.

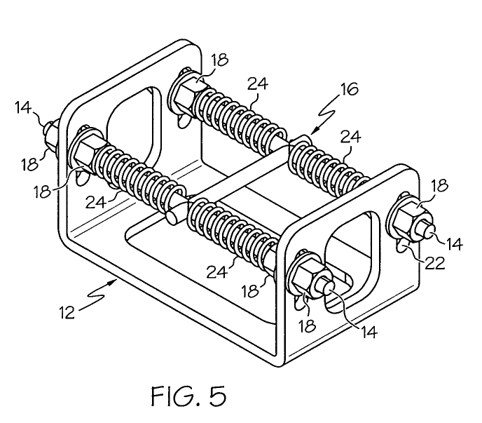

As in FIG. 1, the latch pin 16 is generally at least partially hollow and is slidably attached to at least one dowel 14. In this particular embodiment, there are two dowels 14, but there can be any appropriate number of dowels 14. In one embodiment, the latch pin 16 is a Z-shape (e.g. FIG. 1) and each end 26 of the Z are hollow and can receive a dowel 14. In another embodiment, the latch pin 16 is an H-shape where each of the four ends are hollow and can receive a dowel 14 (e.g. FIG. 5). In this particular embodiment, the latch pin 16 is attached to the dowel 14 by sliding a portion of the dowel into a hollow portion of the latch pin. Thus, the pin 16 can be adjusted in a lateral direction by sliding the pin 16 over the dowel 14. The pin 16 may also be manually adjusted vertically by loosening the nut 18 used to attach the dowel 14 to the latch base 12 and sliding the pin 16, along with the dowel 14, up/or down in the channel 22 located on the latch base 14. The latch assembly 10 can also further comprise at least one spring 24. The spring 24 which surrounds at least a portion of the dowel 14 and at least a portion of the latch pin 16. The at least one spring 24 adds resistance to the slidability of the latch pin 16 over the dowel 14 and also works to return the latch pin 16 to a neutral position when it is not in use. In one embodiment, the latch assembly 10 comprises two springs 24. [Are there any other functions for the spring?]

Because of the capability of the latch for both manual and self-adjustment, if manufacturing tolerances or damage to the closure make the latch assembly 10 (and thus the pin 16) further away from the receiving assembly 32, the length of the pin 16 will compensate for that change as long as it is not greater than the length of the pin 16. This type of need for self adjustment is often seen in vehicle tool boxes because the user will grab the container base 34 and pull on the container base 34 to slide the toolbox closer to the user. This often results in an outward bowing of the base of the toolbox, the inability of an inflexible latch assembly to compensate for the bowing of the container base, and thus the loss of the ability to latch the toolbox. The ability of the latch assembly 10 to compensate for these types of changes or misalignments without any adjustment of the latch assembly 10 by the user is considered self adjustment. If the user has to adjust the latch assembly 10, this is considered manual adjustment.

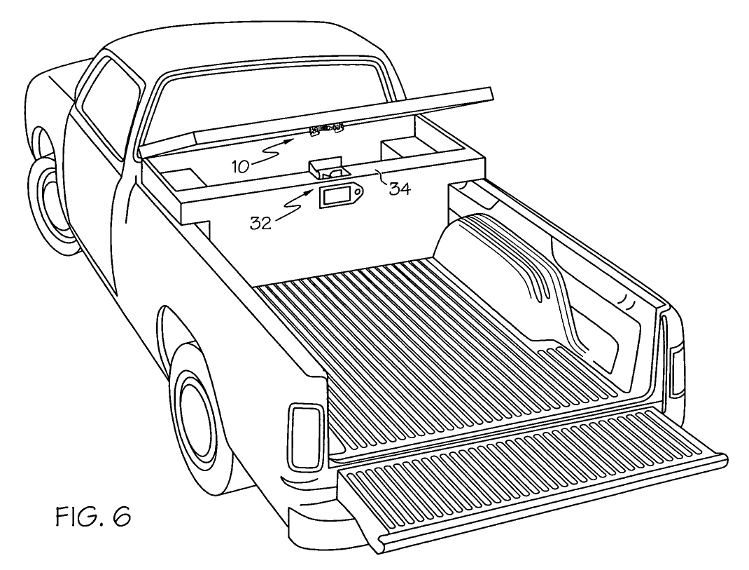

In operation, as seen in FIGS. 3 and 6, a latch system 46, as described above, can be used in a storage container, like a vehicle storage container 52. The vehicle storage container 52 includes a container base 34, a container lid 36, and a latch system 46. The vehicle storage container 52 can have an open and closed position and can be moved between those positions. The latch system 46 includes a latch assembly 10 secured to a first portion 36 of the storage container and a receiving assembly 32 secured to a second portion 34 of the storage container. At least a portion of the latch assembly 10 is moveable with respect to the receiving assembly 32.

Thus, as the container lid 36 is moved toward the container base 34 the user can gauge whether the latch assembly 10 needs to be manually adjusted. If manual adjustment of the latch pin 16 is needed, then the user can loosen a nut 18, slide the latch pin 16 to the new position (either up or down) and tighten the nut 18 to keep the latch pin in the new position. Additionally, when the latch assembly 10 comes into contact with the receiving assembly 32, the latch assembly 10 shifts (either to the left or right) in order to self correct for any misalignment of the latch assembly 10 and the receiving assembly 32. As the latch assembly 10 self corrects, the latch pin 16 pushes against at least one of the opposable sides 38, 40 acting to push the opposable sides 38, 40 apart. The opposable sides 38, 40 slide far enough apart to allow the latch pin 16 to slide between them. Once the pin 16 slides between the opposable sides 38, 40, the two sides return to their original positions and thus releasably engage the latch pin 16. To disengage the latch pin 16, the user can lift the release plate 48 which will pull the opposable sides 38, 40 apart and allow the user to lift the container lid 36 and thus pull the latch pin 16 out from between the two opposable sides 38, 40.

The foregoing description of various embodiments and principles of the invention has been presented for the purposes of illustration and description. It is not intended to be exhaustive or to limit the inventions to the precise forms disclosed. Many alternatives, modifications, and variations will be apparent to those skilled the art. Moreover, although multiple inventive aspects and principles have been presented, these need not be utilized in combination, and various combinations of inventive aspects and principles are possible in light of the various embodiments provided above. Accordingly, the above description is intended to embrace all possible alternatives, modifications, aspects, combinations, principles, and variations that have been discussed or suggested herein, as well as all others that fall within the principles, spirit and scope of the inventions as defined by the claims.

What is claimed is:

1. A latch assembly for releasably latching two components, comprising a latch base and a latch pin, wherein the latch pin is laterally moveable with respect to the latch base.

2. The latch assembly of claim 1, wherein the latch pin has a Z-shape.

3. The latch assembly of claim 1, wherein the latch pin has an H-shape.

4. The latch assembly of claim 1, further comprising at least one spring.

5. The latch assembly of claim 1, wherein the latch pin is moveable horizontally, vertically, or a combination thereof.

6. The latch assembly of claim 1, wherein the latch pin is slidably attached to a dowel.

7. The latch assembly of claim 1, wherein at least a portion of the dowel comprises an engageable surface.

8. The latch assembly of claim 7, wherein the engageable surface is configured to allow for self adjustment in height.

9. The latch assembly of claim 7, wherein at least of portion of the dowel passes through a channel on the latch base and is attached to the latch base via at least one nut.

10. The latch assembly of claim 1, wherein the latch pin is moveable with respect to the dowel.

11. The latch assembly of claim 1, further comprising a receiving assembly, wherein the receiving assembly is configured to releasably retain the latch pin.

12. The latch assembly of claim 10, wherein the latch assembly is used in a storage container.

13. A latch system for a vehicle storage container, the storage container having an open and closed position, the latch system comprising a latch assembly secured to a first portion of the storage container and a receiving assembly secured to a second portion of the storage container, wherein the latch assembly comprises a latch base and a latch pin wherein when said storage container is moved between said open and closed position at least a portion of the latch assembly is laterally moveable with respect to the receiving assembly.

14. The latch system of claim 13, wherein the latch assembly is moveable horizontally, vertically, or a combination thereof.

15. A vehicle storage container, comprising a container base, a container lid, and a latch system, wherein the latch system comprises a latch assembly secured to one of the container lid or container base and a receiving assembly secured to the other of the container lid or container base, wherein at least a portion of the latch assembly is laterally moveable with respect to the receiving assembly.

16. The vehicle storage container of claim 15, wherein the latch assembly comprises a latch pin and a latch base and the latch pin is moveable with respect to the latch base.

17. The latch assembly of claim 6, wherein the latch pin is slidably attached to the dowel.

18. The latch assembly of claim 17, wherein the latch assembly further comprise a dowel and at least a portion of the dowel comprises an engageable surface which is configured to allow for self adjustment in height.

19. The vehicle storage container of claim 18, wherein the latch assembly further comprises at least one spring which surrounds at least a portion of the dowel and at least a portion of the latch pin.

20. The vehicle storage container of claim 15, wherein the receiving assembly comprises two opposable sides, wherein the opposable sides releasably engage the latch pin when the container lid is seated on the container base
